(19) United States
(12) Patent Application Publication
(10) Pub. No.: US 2005/0212235 A1
(43) Pub. Date: Sep. 29, 2005

(54) Shopping cart assembly

(76) Inventor: Nicholas Hammerling, Penn Yan, NY (US)

Correspondence Address: Thomas R. FitzGerald, Esq., Ste. 210, 16 E. Main St., Rochester, NY, 14614-1808, US

(21) Appl. No.: 10/966,163

(22) Filed: Oct. 15, 2004

Related U.S. Application Data
(60) Provisional application No. 60/551,445, filed on Mar. 9, 2004.

(51) Int. Cl. B62D 39/00

(52) U.S. Cl. 280/33.992

(57) ABSTRACT

A shopping cart assembly includes a shopping cart having opposing cart sidewalls, a cart bottom, and a cart rear wall. A main basket is defined by the cart sidewalls and the cart bottom. A second basket is defined by the cart sidewalls and the cart rear wall. The second basket has a seat portion and a front wall, which is pivotally attached to the rear cart wall. The seat portion is pivotally coupled to each of the rear cart wall and the front wall. The second basket is collapsible. A holder is disposed within the second basket and is attached to one of the cart sidewalls. The holder is shaped to correspond to the cross-sectional shape of the second basket. The holder has first and second pockets, and is constructed of a mesh or transparent material.

### CROSS-REFERENCE TO RELATED APPLICATIONS

This application claims the benefit of the priority date of U.S. provisional patent application Ser. No. 60/551,445 filed Oct. 15, 2003.

### TECHNICAL FIELD

The present invention relates to shopping carts and accessories for use therewith.

### BACKGROUND

Shopping carts are used to hold and carry items a shopper has selected while the shopper continues to look for and select other items or browses through the store, or to transport the selected items to the cashier. Shopping carts typically have a relatively large main basket and a smaller, collapsible basket. The smaller, collapsible basket is nested within the main basket and shares common sidewalls therewith, i.e., a portion of the main basket sidewalls form the sidewalls of the smaller basket. The main and smaller baskets also share a common rear wall, i.e., a portion of the main basket rear wall forms the rear wall of the smaller basket, which is proximate to the handle of the shopping cart. The smaller, collapsible basket includes a bottom wall and a front wall. The bottom and front walls of the smaller basket are pivotable such that the smaller basket is collapsible against the rear wall of the cart. The rear wall of the cart, in turn, is pivotable to provide for nesting of one shopping cart at least partially within another for storage.

The main basket is generally used to hold relatively large goods, such as canned goods, selected by the shopper. The smaller basket is designed for use as a seat for toddlers. Shoppers without toddlers often use the smaller, collapsible basket to carry small, delicate, or fragile, items that might be damaged if placed among the larger items in the main basket.

The main basket of a shopping cart is typically constructed of a mesh of heavy duty metal or plastic material. The mesh has relatively large voids or holes between the structural material through which many smaller items or goods are able to pass. Even when smaller items are carefully placed in the main basket in an orientation that prevents them from falling through the voids in the basket, the smaller items may be jostled or otherwise re-oriented during shopping such that they end up falling through one of the voids and out of the cart. The smaller basket has similar, if not larger, voids in the mesh. Further, the bottom and front walls of the smaller basket are spaced apart from the side walls that are shared with the main basket to thereby permit the smaller basket to be collapsed. The gaps between the shared sidewalls and the bottom and front walls of the smaller basket similarly permit smaller items to drop out of the smaller basket and/or out of the cart entirely.

Therefore, what is needed in the art is a shopping cart assembly that provides for secure storage of relatively small and/or delicate items.

Furthermore, what is needed in the art is a holder that is attachable to a shopping cart for securely holding relatively small and/or delicate items.

Moreover, what is needed in the art is a holder that is attachable to a shopping cart for securely holding relatively small and/or delicate items and which does not have to be removed from the cart to permit collapsing of the smaller basket and pivoting of the cart rear wall to thereby enabling nesting of the carts.

### SUMMARY OF THE INVENTION

The present invention provides a holder for use with a shopping cart.

The invention comprises, in one form thereof, a shopping cart having opposing cart sidewalls, a cart bottom, and a cart rear wall. A main basket is defined by the cart sidewalls and the cart bottom. A second basket is defined by the cart sidewalls and the cart rear wall. The second basket has a seat portion and a front wall, which is pivotally attached to the rear cart wall. The seat portion is pivotally coupled to each of the rear cart wall and the front wall. The second basket is collapsible. A holder is disposed within the second basket and is attached to one of the cart sidewalls. The holder is shaped to correspond to the cross-sectional shape of the second basket. The holder has first and second pockets, and is constructed of a mesh or transparent material.

### BRIEF DESCRIPTION OF THE DRAWINGS

The above-mentioned and other features and advantages of this invention, and the manner of attaining them, will become apparent and be more completely understood by reference to the following description of one embodiment of the invention when read in conjunction with the accompanying drawings, wherein:

FIG. 1 is an exploded view of a shopping cart assembly of the present invention; and

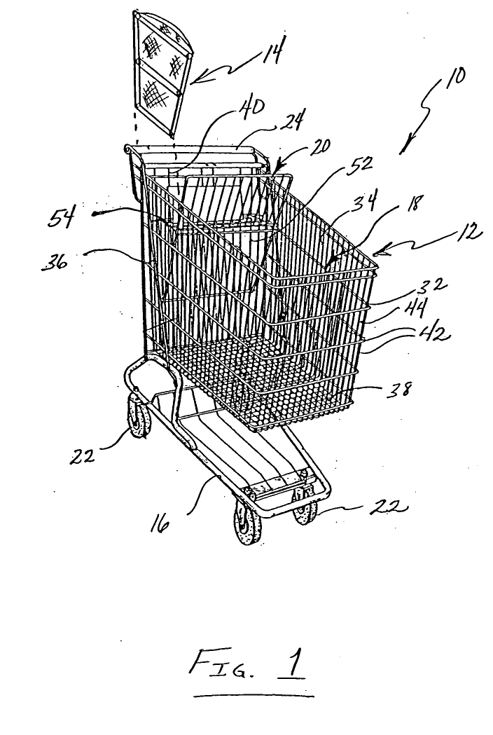

FIG. 2 is a side or front view of the holder of the shopping cart assembly of FIG. 1.

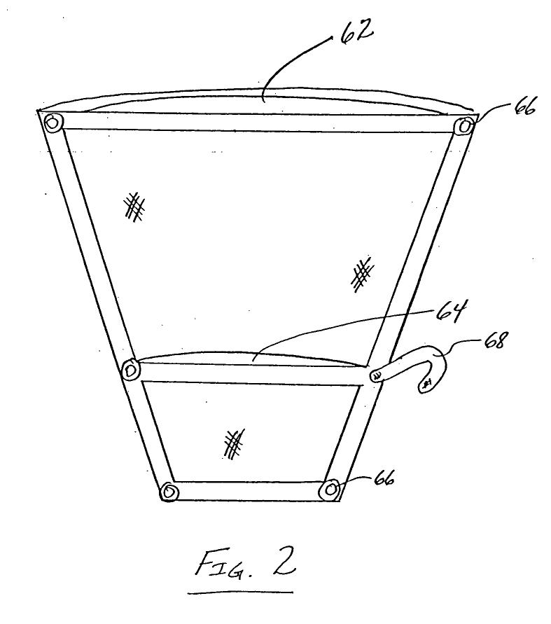

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE DRAWINGS

Referring now to the drawings, one embodiment of a shopping cart and holder assembly of the present invention is shown. Shopping cart assembly 10 includes shopping cart 12 and holder 14.

Shopping cart 10 includes frame 16, main or first basket 18, second or collapsible basket 20, wheels 22 and handle 24. First or main basket 18 includes front wall 32, side walls 34 and 36, bottom 38, and rear wall 40, all of which are formed of an interconnected mesh of structural members 42, constructed of, for example, metal or plastic material, that define voids 44 therebetween.

Second or collapsible basket 20 includes front wall 52 and seat portion 54. Second basket 20 is defined in part by and shares front wall 32 and sidewalls 34, 36 of main basket 18. Front wall 52 is pivotally connected to rear wall 40 of main basket 18. Seat portion 54 is pivotally connected to rear wall 40 and to front wall 52. Second basket 20, shown in the expanded or in use position, is collapsible onto and to be substantially flat with rear wall 40. More particularly, front wall 52 and seat portion 54 of second basket 20 are pivotable into an orientation wherein front wall 52 and seat portion 54 are generally parallel with and adjacent to rear wall 40 of first basket 18.

Holder 14 includes first relatively large pocket 62 and second shallower or smaller pocket 64. Holder 14 is preferably disposed within and is secured to one of sidewalls 34, 36 of second basket 20. Holder 14 is shaped to generally match the cross-sectional shape (typically a truncated triangle) of second basket 20. Holder 14 includes grommets 66 that accept securing means, such as, for example, cloth or nylon ties (not shown) for securing holder 14 to one of sidewalls 34, 36 within second basket 20 of shopping cart 10. Alternatively, holder 14 includes integral securing means, such as, for example, ties having hook-and-loop fasteners 68. Holder 14 is preferably constructed of a transparent or mesh material, such as, for example, plastic or nylon mesh, upon which advertisements or other information can be printed.

In use, holder 14 is preferably secured to one of sidewalls 34, 36 of second basket 20. Since holder 14 is formed similarly to a pocket, it is basically flat when empty and therefore generally lies against or in close proximity to the sidewall 34, 36 to which it is secured. Thus, holder 14 does not interfere with the ability of rear wall 40 of main basket 18 to pivot, nor does holder 14 interfere with the ability to collapse second basket 20, each of which are necessary when nesting carts for storage. Further, since holder 14 is formed from a mesh or transparent material, the checkout clerk can see what is contained within holder 14. Thus, losses due to theft or mistake are prevented. When attached to sidewalls 34 or 36 with removable fastening means, such as hook-and-loop type fasteners 68, holder 14 may be removed and placed directly on the checkout counter thereby reducing the number of times the small and/or delicate items therein must be handled.

First or large pocket 62 is used to store larger relatively delicate items, such as, for example, magazines, greeting cards or other items, that might otherwise incur damage if placed in main basket 18. Smaller items, such as, for example, lipstick and small batteries, are placed in second or smaller pocket 64.

1. A shopping cart assembly, comprising:
a shopping cart having opposing cart sidewalls, a cart bottom, and a cart rear wall, a main basket defined by said cart sidewalls and said cart bottom, a second basket defined at least in part by said cart sidewalls and said cart rear wall, said second basket having a seat portion and a front wall, said front wall pivotally attached to said rear cart wall, said seat portion pivotally coupled to each of said rear cart wall and said front wall, said second basket being collapsible; and
a holder, said holder being disposed within said second basket and being attached to one of said cart sidewalls, said holder being shaped to generally correspond to a cross-sectional shape of said second basket, said holder having first and second pockets and being constructed of one of a mesh and transparent material.

2. A holder for use with a shopping cart, the shopping cart having a second basket defined at least in part by sidewalls of the cart and a rear wall of the cart, said holder comprising:
a holder configured for being disposed within said second basket and for being attached to one of the sidewalls of the cart, said holder being shaped to generally correspond to a cross-sectional shape of the second basket, said holder having first and second pockets and being constructed of one of a mesh and transparent material.

3. The holder of claim 2, further comprising hook-and-loop fasteners configured for attaching said holder to one of the shopping cart sidewalls.
